(19) United States
(12) Patent Application Publication
(10) Pub. No.: US 2023/0109844 A1
(43) Pub. Date: Apr. 13, 2023

(54) PAINTING DEVICE

(71) Applicant: ABB Schweiz AG, Baden (CH)

(72) Inventor: Kuniharu Yamauchi, Tokyo (JP)

(21) Appl. No.: 17/937,231

(22) Filed: Sep. 30, 2022

(30) Foreign Application Priority Data
Oct. 8, 2021 (JP) 2021-166268

(51) Int. Cl. B05B 15/55

(52) U.S. Cl. CPC B05B 15/557

(57) ABSTRACT

A painting device equipped with a painting head having multiple nozzles that discharge coating material toward an object of painting. The painting device includes a supply passage that supplies the coating material to the painting head, and a return flow passage that returns, to the upstream side of the supply passage. A portion of the coating material supplied to the painting head that was not discharged from the multiple nozzles is possessed by the painting head, wherein the supply passage, the painting head, and the return flow passage constitute a coating material circulation passage. The coating material circulation passage is divided into multiple segments, each of which contains at least one of the multiple circuit component parts arranged in the coating material circulation passage or the painting head, and wherein the coating material circulation passage allows the multiple segments to be cleaned individually.

### TECHNICAL FIELD

The present invention relates to a painting device equipped with a painting head having multiple nozzles that spray out a coating material.

### BACKGROUND

Painting devices that perform painting using a painting head having multiple nozzles are used in many fields. For example, in automobile manufacturing plants, painting robots are used, which paint the vehicle body of an automobile by moving a painting head installed on a robot arm along the body of the automobile. A painting robot may in some cases perform painting of a vehicle body while switching to coating materials of different colors. When switching the color of the coating material used for painting, cleaning liquid is passed through the coating material supply passage to clean the supply passage, thereby preventing the previously used coating material color from mixing with the color of the coating material to be newly used (see patent document 1).

### PRIOR ART DOCUMENTS

### Patent Documents

[Patent document 1] Japanese Unexamined Patent Application Publication 2020-501881

### SUMMARY

### Problem to be Solved by the Invention

In the painting device described above, the coating material used is a coating material comprising pigment as a main component. Thus, for example, even when painting of an automobile body has been stopped, coating material is circulated to prevent the pigment contained in the coating material from separating or aggregating. For example, the passage through which the coating material is circulated (hereinafter, the coating material circulation passage) comprises many component parts besides the aforementioned painting head, such as a pump for circulating the coating material, etc. The adhesion state of coating material in such a coating material circulation passage differs depending on the component part, and also differs due to concavoconvexities or level differences provided at the connection areas between piping and component parts. Therefore, when cleaning liquid is passed through the coating material circulation passage to clean the coating material circulation passage, the manner in which the coating material adhered to the coating material circulation passage comes off will differ, and in areas where coating material is difficult to wash off with cleaning liquid, residual coating material (more specifically, pigment) will tend to remain.

Furthermore, in the case of a method wherein cleaning liquid is passed through starting from the upstream side of the coating material supply passage or coating material circulation passage to clean the supply passage, the coating material removed by cleaning flows together with the cleaning liquid, so it becomes difficult to obtain a cleaning effect from the cleaning liquid on the downstream side. Thus, there is the problem that, in a method of cleaning by passing cleaning liquid through starting from the upstream side of the supply passage, the cleaning time is prolonged.

The present invention was invented to resolve the problems described above, and has the purpose of providing technology that allows the cleaning time of the coating material circulation passage to be shortened by efficiently obtaining a cleaning effect on the coating material circulation passage in a shorter time.

### Means for Solving the Problem

The painting device of the present invention, intended to solve the problem described above, is a painting device equipped with a painting head having multiple nozzles that discharge coating material, the painting device being characterized in that it comprises a supply passage that supplies the coating material to the painting head, and a return flow passage that returns, to the upstream side of the supply passage, the portion of the coating material supplied to the painting head that was not discharged from the multiple nozzles possessed by the painting head, wherein the supply passage, the painting head and the return flow passage constitute a coating material circulation passage, wherein the coating material circulation passage is divided into multiple segments, each of which contains at least one of the multiple circuit component parts arranged in the coating material circulation passage or the painting head, and wherein the coating material circulation passage allows the multiple segments to be cleaned individually.

The painting device is furthermore characterized in that the multiple segments include a segment in which a first pump that feeds the coating material to the painting head is arranged. The painting device is furthermore characterized in that the multiple segments include a segment in which a filter for removing aggregates contained in the coating material fed from the first pump is arranged.

The painting device is furthermore characterized in that the multiple segments include a segment in which a remover for removing air bubbles contained in the coating material fed from the feed pump is arranged.

The painting device is furthermore characterized in that the multiple segments include a segment in which the painting head is arranged. In this case, the segment in which the painting head is arranged preferably includes a bypass flow passage that causes the coating material supplied to the given segment to flow to the return flow passage without going through the painting head.

The painting device is furthermore characterized in that the multiple segments include a segment in which there is arranged a second pump which draws into the return flow passage, and feeds to the upstream side of the supply passage, the coating material supplied to the painting head that was not discharged from the multiple nozzles possessed by the painting head.

The painting device is furthermore characterized in that cleaning of each segment among said multiple segments is carried out by repeating, one or multiple times, the operation of supplying the cleaning liquid to the segment that is to be cleaned, then supplying the air to that segment, and discharging at least a portion of the supplied cleaning liquid, wherein the supplied quantity of the cleaning liquid and the air in the cleaning operation and the number of repetitions of the cleaning operation differ for each segment among the multiple segments.

The painting device is furthermore characterized in that the coating material circulation passage is divided into the multiple segments by arranging switching valves at multiple locations, wherein the switching valves include a first valve part which is opened when, between two adjacent segments, the coating material is to be passed from the segment located upstream to the segment located downstream in the coating material supply direction; a second valve part which is opened when cleaning liquid or air is to be fed into one of the two adjacent segments; and a third valve part which is opened when the cleaning liquid or the air that has flowed through one of the two adjacent segments is to be discharged to the outside.

The painting device is furthermore characterized in that the painting device is a painting robot which has a robot arm that holds the painting head, and paints an object of painting through actuation of the robot arm and discharge of the coating material from the multiple nozzles possessed by the painting head.

### Effect of the Invention

According to the present invention, it is possible to shorten the cleaning time of a coating material circulation passage by more efficiently obtaining a cleaning effect on the coating material circulation passage.

### BRIEF DESCRIPTION OF THE DRAWINGS

FIG. 1 is a drawing illustrating an example of a painting robot that implements the present invention.

FIG. 2 is a drawing illustrating a schematic example of a coating material circulation circuit.

FIG. 3 is a flow chart illustrating an example of the flow for cleaning a head section.

FIG. 4 is a flow chart illustrating an example of the flow for cleaning a filter section and a degassing section as one segment.

### DETAILED DESCRIPTION

A painting robot 11 which implements the present invention will be described below on the basis of the drawings. The painting robot 11 of the present embodiment is arranged to the side of a painting line in an automobile manufacturing plant and is used for painting vehicle bodies FR conveyed along the painting line. While a painting robot 11 is illustrated below as the painting device of the present invention, the painting device of the present invention can be any painting device having a coating material circulation passage 41 as described below and is not limited to the painting robot 11. Furthermore, with regard to the configuration of the painting robot 11, a painting robot is illustrated which is capable of moving a painting head unit 24 in three axial directions of X axis, Y axis and Z axis, but the painting robot may also be one which moves the painting head unit 24 in one of the X axis, Y axis or Z axis directions, or a painting robot which moves the painting head unit 24 in the XY plane, YZ plane or XZ plane.

Although illustration of this will be omitted, the painting robot 11 performs painting on a vehicle body FR which is conveyed, for example, from the upstream side of the aforementioned painting line. Here, the painting robot 11 may either perform painting on a vehicle body FR that is being conveyed on the painting line, or the painting robot may perform painting on a vehicle body FR that has been conveyed to a predetermined location on the painting line and then stopped. A vehicle body FR which on which painting has been performed by the painting robot 11 is conveyed to the downstream side of the painting line.

While the vehicle body FR of an automobile is taken as an example of the object of painting in the following description, the object of painting may also be an automobile part other than a vehicle body (examples include, but are not limited to, doors, hoods, various panels, etc.), or various parts other than automobile parts (for example, airplane or railway exterior parts), and thus is not limited to a vehicle body of an automobile and may be any object that requires painting.

Painting here is performed for the purpose of forming a coating film on the surface of the object of painting to provide protection of that surface and improved appearance. Therefore, painting includes not only the painting of an object of painting using coating material of a specific color or coating material having a specific function, but also the painting of an object of painting using coating materials of multiple colors in sequence. Furthermore, painting includes painting of patterns, illustrations, images, etc.

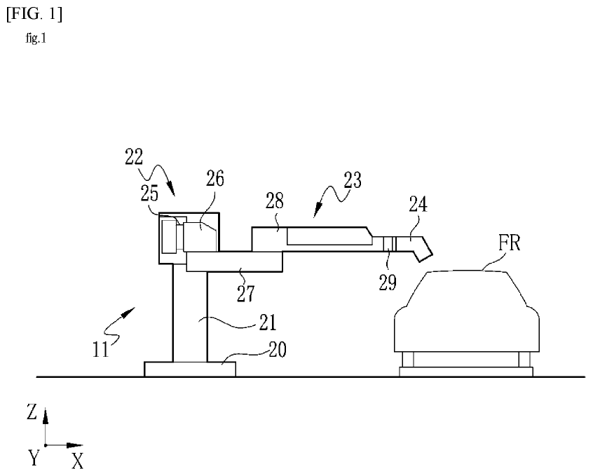

The painting robot 11 is, for example, a multi-jointed robot, but may also be a SCARA robot, so long as it is capable of painting. The painting robot 11 shown in FIG. 1, as an example, has a base 20, a leg part 21, a rotary drive part 22, a robot arm 23 and a painting head unit 24. The base 20 is a member which holds the bottom end side of the leg part 21 that extends vertically, and which supports the entire painting robot 11. The base 20 may for example be fixed to the floor of the painting line or may be movable over the floor of the painting line.

The rotary drive part 22 is provided at the upper end of the leg part 21. The rotary drive part 22 includes a rotary shaft part 25 and a rotary arm 26. The rotary shaft part 25 rotates the rotary arm 26 through driving with an unillustrated motor, about a center of rotation consisting of, for example, a straight line (in FIG. 1, for example, the X axis direction) contained within a plane parallel to the floor. The rotary arm 26 rotates the robot arm 23, connected to the rotary arm 26, about a center of rotation consisting of, for example, a straight line (in FIG. 1, for example, the Z axis direction) orthogonal to the center of rotation of the rotary shaft part 25.

The robot arm 23 includes a first turning arm 27 and a second turning arm 28. The first turning arm 27 is connected to the rotary arm 26 at one end in the direction of extension of the first turning arm 27 (in FIG. 1, for example, the X axis direction), and turns about a center of turning consisting of a straight line contained in a plane orthogonal to the axial direction of the rotary shaft part 25 through driving by an unillustrated motor.

The second turning arm 28 is connected to the first turning arm 27 at the other end in the direction of extension of the first turning arm 27 (in FIG. 1, for example, the X axis direction), and turns about a center of turning consisting of a straight line (in FIG. 1, for example, the Z axis direction) extending parallel to the direction of the center of rotation of the first turning arm 27 on the rotary arm 26.

Furthermore, the second turning arm 28 holds a wrist part 29 on the other end opposite to the end that is pivotally attached to the first turning arm 27. The wrist part 29, in a state where the painting head unit 24 has been held, rotates the held painting head unit 24 about a center of rotation consisting of any of the multiple axes which the wrist part itself possesses. Here, the multiple axes are, for example, three axes of different orientation. It should be noted that the number of axes should be two or more.

The painting head unit 24 has a painting head 47, circuit component parts including a coating material circulation passage 41 and the painting head 47, and as well as a control unit (illustration omitted) which controls the operation of the painting head 47 and the coating material circulation passage 41, etc.

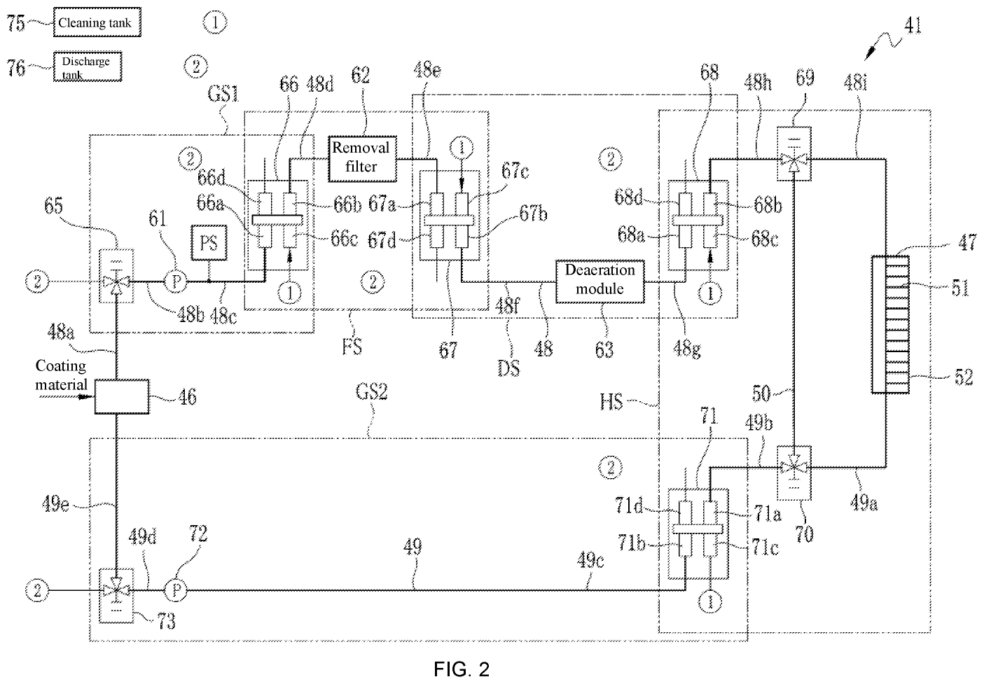

FIG. 2 is a drawing illustrating the schematic configuration of the coating material circulation passage 41. As shown in FIG. 2, the coating material circulation passage 41 comprises a coating material tank 46, a painting head 47, a supply passage 48, a return flow passage 49 and a bypass flow passage 50. The coating material circulation passage 41 enables circulation of the coating material stored in the coating material tank 46. For example, when performing painting on a vehicle body FR, in the coating material circulation passage 41, the coating material stored in the coating material tank 46 is supplied via the supply passage 48 to the painting head 47, and the coating material which was not used up for painting by the painting head 47 is returned via the return flow passage 49 to the coating material tank 46. Furthermore, when not performing painting on the vehicle body FR, in the coating material circulation passage 41, the coating material stored in the coating material tank 46 is made to flow through the supply passage 48, bypass flow passage 50 and return flow passage 49 in that order and is returned to the coating material tank 46.

In describing the configuration of the coating material circulation passage 41 within the supply passage 48, with respect to the supply direction of the coating material, the coating material tank 46 side will be referred to as the upstream side and the painting head 47 side will be referred to as the downstream side. Furthermore, in describing the configuration of the coating material circulation passage 41 within the return flow passage 49, the painting head 47 will be referred to as the upstream side and the coating material tank 46 side will be referred to as the downstream side.

The coating material tank 46 stores coating material to be used during painting of the vehicle body FR using the painting head 47. The coating material tank 46 is arranged, for example, outside the painting robot 11 (for example, on the floor of the painting room) or on the robot arm 23. It will be noted that coating material is supplied to the coating material tank 46 from outside as necessary in the process of performing painting of the vehicle body FR using the painting head 47.

The coating material is for example a water-based coating material or solvent-based coating material using pigment. Therefore, in the present embodiment, the coating material is circulated inside the coating material circulation passage 41 to prevent the phenomenon of separation of the pigment contained in the coating material or aggregation of the pigment in the coating material circulation passage 41. Furthermore, by circulating the coating material, the viscosity of the coating material is reduced.

The painting head 47 has a nozzle forming surface 52 on which multiple nozzles 51 are arrayed two-dimensionally, and forms a coating film on the surface of the vehicle body FR by discharging coating material, supplied via the supply passage 48, from each of the multiple nozzles 51. The detailed configuration of the painting head 47 will be omitted.

The supply passage 48 is a passage which supplies the coating material stored in the coating material tank 46 to the painting head 47. The supply passage 48 has flow passages 48a, 48b, 48h, 48i, described later. Furthermore, to the supply passage 48, going from the coating material tank 46 toward the painting head 47, there are connected a gear pump 61, a removal filter 62 and a deaeration module 63, in the order gear pump 61—removal filter 62—deaeration module 63.

The gear pump 61 is arranged, for example, inside the second turning arm 28 of the robot arm 23. The gear pump 61 draws in coating material stored in the coating material tank 46, the feeds the drawn-in coating material toward the painting head 47. Therefore, the pressure on the upstream side of the gear pump 61, i.e. inside the flow passages 48a, 48b between the coating material tank 46 and the gear pump 61, becomes negative, and the coating material stored in the coating material tank 46 is drawn into these flow passages 48a, 48b and is then fed from the gear pump 61 to the flow passage 48c that is connected to the downstream side of the gear pump 61. Here, the gear pump 61 corresponds to the first pump as set forth in the claims.

Within the supply passage 48, a three-way valve 65 is connected between the coating material tank 46 and the gear pump 61. The three-way valve 65 switches between a state in which flow passage 48a is interconnected with flow passage 48b, and a state in which flow passage 48b is interconnected with discharge tank 76. During painting of the vehicle body FR by means of the painting head 47, the three-way valve 65 holds the flow passage 48a and the flow passage 48b in an interconnected state, and the coating material stored in the coating material tank 46 is made to flow into the supply passage 48 by actuating the aforementioned gear pump 61. Furthermore, during cleaning, the three-way valve 65 switches from a state in which the flow passage 48a is interconnected with the flow passage 48b to a state in which the flow passage 48b is interconnected with the discharge tank 76, and the cleaning liquid and air flowing through the flow passage 48b in the opposite direction of the coating material supply direction are discharged into the discharge tank 76. Here, the cleaning liquid, when using a coating material that is a mixture of organic solvent and pigment (solvent-based coating material) (in some cases also containing metal granules or metal flakes), is a cleaning liquid having organic solvent as the main ingredient, and in cases of using a coating material using water and pigment (water-based coating material) (in some cases also containing metal granules or metal flakes), the cleaning liquid has water as the main ingredient. Furthermore, the air used for cleaning is compressed air. In the following, the term “air” refers to compressed air.

Within the supply passage 48, a pressure gauge PS is connected to the flow passage 48c that is on the downstream side of the gear pump 61. The pressure gauge PS measures the pressure of coating material fed by the gear pump 61. The gear pump 61 is driven and controlled such that the pressure value detected by the pressure gauge PS remains at a constant value.

The supply passage 48 connects the switching valve 66 to the downstream side end of the flow passage 48c. The switching valve 66 has four valve parts 66a, 66b, 66c, 66d, and is able to switch the flow passage of liquid (coating material, cleaning liquid) or gas (air used during cleaning) according to the open/closed state of these valve parts 66a, 66b, 66c, 66d. Here, valves parts 66a, 66b correspond to the first valve part as set forth in the claims. Furthermore, valve part 66c corresponds to the second valve part as set forth in the claims. Moreover, valve part 66d corresponds to the third valve part as set forth in the claims.

For example, valve part 66a is connected to flow passage 48c, and valve part 66b is connected to the flow passage 48d that leads to the removal filter 62. Therefore, for example, during supply of coating material heading from the coating material tank 46 to the painting head 47, or during circulation of coating material, these valves 66a and 66b are opened, and the coating material from flow passage 48c flows toward flow passage 48d.

Furthermore, valve part 66c is connected to the cleaning tank 75 (more specifically, to an unillustrated flow passage that is connected to the cleaning tank 75). Therefore, for example, during cleaning, if one of the aforementioned valve part 66a or valve part 66b and the valve part 66c are opened, the cleaning liquid supplied from the cleaning tank 75 will flow through the opened valve parts into the flow passages connected to the given valve parts.

Furthermore, valve part 66d is connected to the discharge tank 76 (more specifically to an unillustrated flow passage that is connected to the discharge tank 76). Therefore, for example, during cleaning, if one of the aforementioned valve part 66a or valve part 66b and the valve part 66d are opened, the cleaning liquid or air that has flowed through the flow passages connected to the opened valve parts will flow through valve part 66d into the discharge tank 76.

In the supply passage 48, on the downstream side of the flow passage 48d connected to the valve part 66b of the switching valve 66, there is connected a removal filter 62. The removal filter 62 is installed at a location where operation of the painting robot 11 will not affect removal performance of the removal filter 62, such as on the leg part 21 of the painting robot 11 or the floor of the painting line. The removal filter 62 removes coarse foreign matter and foreign matter such as pigment aggregates contained in the coating material that flows through the supply passage 48, and also removes air bubbles contained in the coating material which exceed a predetermined size. The removal filter 62 is for example a mesh-like body such as a metal net or resin net, or a porous body, or a metal plate in which fine through-holes have been formed. Examples of a mesh-like body include metal mesh filters, metal fibers, e.g. fine strands of metal known as SUS made into the form of felt, metal sintered filters which have been compressed and sintered, electroformed metal filters, electron beam processed metal filters, laser beam processed metal filters, and the like. Here, the removal filter 62 corresponds to the filter as set forth in the claims.

In the supply passage 48, on the downstream side of the flow passage 48e connected to the downstream side of the removal filter 62, there is connected a switching valve 67. The switching valve 67, similarly, to switching valve 66, has four valve parts 67a, 67b, 67c, 67d. Here, valves parts 67a, 67b correspond to the first valve part as set forth in the claims. Furthermore, valve part 67c corresponds to the second valve part as set forth in the claims. Moreover, valve part 67d corresponds to the third valve part as set forth in the claims.

For example, valve part 67a is connected to flow passage 48e, and valve part 67b is connected to the flow passage 48f that leads to the deaeration module 63. Therefore, for example, during supply of coating material heading from the coating material tank 46 to the painting head 47, or during circulation of coating material, these valves 67a and 67b are opened, and the coating material from flow passage 48e flows toward flow passage 48f.

Furthermore, valve part 67c is connected to the cleaning tank 75 (more specifically, to an unillustrated flow passage that is connected to the cleaning tank 75). Therefore, for example, during cleaning, if one of the aforementioned valve part 67a or valve part 67b and the valve part 67c are opened, the cleaning liquid supplied from the cleaning tank 75 will flow through the opened valve parts into the flow passages connected to the given valve parts.

Furthermore, valve part 67d is connected to the discharge tank 76 (more specifically to an unillustrated flow passage that is connected to the discharge tank 76). Therefore, for example, during cleaning, if one of the aforementioned valve part 67a or valve part 67b and the valve part 67d are opened, the cleaning liquid or air that has flowed through the flow passages connected to the opened valve parts will flow through valve part 67d into the discharge tank 76.

In the supply passage 48, on the downstream side of the flow passage 48f connected to the valve part 67b of the switching valve 67, there is connected a deaeration module 63. The deaeration module 63 is installed at a location where operation of the painting robot 11 will not affect the deaeration performance of the deaeration module 63, such as on the leg part 21 of the painting robot 11 or the floor of the painting line. The deaeration module 63 removes (deaerates) dissolved gas and air bubbles present in the coating material. Examples of the deaeration module 63 include a hollow fiber membrane bundle made by bundling multiple hollow fiber membranes. Here, the deaeration module 63 corresponds to the remover as set forth in the claims.

In the supply passage 48, on the downstream side of the flow passage 48g connected to the downstream side of the removal filter 62, there is connected a switching valve 68. The switching valve 68, similarly to switching valve 66 and switching valve 67, has four valve parts 68a, 68b, 68c, 68d. Here, valves parts 68a, 68b correspond to the first valve part as set forth in the claims. Furthermore, valve part 68c corresponds to the second valve part as set forth in the claims. Moreover, valve part 68d corresponds to the third valve part as set forth in the claims.

For example, valve part 68a is connected to flow passage 48g, and valve part 68b is connected to the flow passage 48h that leads to the three-way valve, described later. Therefore, for example, during supply of coating material heading from the coating material tank 46 to the painting head 47, or during circulation of coating material, these valves 68a and 68b are opened, and the coating material flowing through flow passage 48g flows toward flow passage 48h.

Furthermore, valve part 68c is connected to the cleaning tank 75 (more specifically, to an unillustrated flow passage that is connected to the cleaning tank 75). Therefore, for example, during cleaning, if one of the aforementioned valve part 68a or valve part 68b and the valve part 68c are opened, the cleaning liquid supplied from the cleaning tank 75 will flow through the opened valve parts into the flow passages connected to the given valve parts.

Furthermore, valve part 68d is connected to the discharge tank 76 (more specifically to an unillustrated flow passage that is connected to the discharge tank 76). Therefore, for example, during cleaning, if one of the aforementioned valve part 68a or valve part 68b and the valve part 68d are opened, the cleaning liquid or air that has flowed through the flow passages connected to the opened valve parts will flow through valve part 68d into the discharge tank 76.

In the supply passage 48, on the downstream side of the flow passage 48h connected to the valve part 68b of the switching valve 68, there is connected a three-way valve 69. During painting of the vehicle body FR by means of the painting head 47, the three-way valve 69 maintains the flow passage 48h and the flow passage 48i connected to the painting head 47 on the downstream side in an interconnected state. Furthermore, when painting of the vehicle body FR by means of the painting head 47 is not being performed, the three-way valve 69 switches from a state in which flow passage 48h and flow passage 48i are interconnected to a state where flow passage 48h and bypass flow passage 50 are interconnected.

The downstream side of the flow passage 48i and the upstream side of flow passage 49a of the return flow passage 49, described below, are connected to the painting head 47. In the return flow passage 49, a three-way valve 70 is connected to the downstream side of flow passage 49a. During painting of the vehicle body FR by means of the painting head 47, the three-way valve 70 maintains the flow passage 49a and the flow passage 49b, which is connected to valve part 71a of switching valve 71, described below, on the downstream side, in an interconnected state. Furthermore, when painting of the vehicle body FR by means of the painting head 47 is not being performed, the three-way valve 70 switches from a state in which flow passage 49a and flow passage 49b are interconnected to a state where bypass flow passage 50 and flow passage 49b interconnected.

The return flow passage 49 returns coating material that was not used by the painting head 47, or coating material which is circulating through the coating material circulation passage 41, to the upstream side of the supply passage 48, that is, toward the coating material tank 46. The return flow passage 49 has flow passages 49a, 49b, 49c, 49d, 49e.

In the return flow passage 49, a switching valve 71 is connected to the downstream side of flow passage 49b. The switching valve 71, similarly to switching valve 66, switching valve 67 and switching valve 68, has four valve parts 71a, 71b, 71c, 71d. Here, valves parts 71a, 71b correspond to the first valve part as set forth in the claims. Furthermore, valve part 71c corresponds to the second valve part as set forth in the claims. Moreover, valve part 71d corresponds to the third valve part as set forth in the claims.

For example, valve part 71a is connected to flow passage 49b and valve part 71b is connected to flow passage 49c, which connects to gear pump 72, on the downstream side. Therefore, for example, during supply of coating material heading from the coating material tank 46 to the painting head 47, or during circulation of coating material, these valves 71a and 71b are opened, and the coating material flowing through flow passage 49b flows toward flow passage 49c.

Furthermore, valve part 71c is connected to the cleaning tank 75 (more specifically, to an unillustrated flow passage that is connected to the cleaning tank 75). Therefore, for example, during cleaning, if one of the aforementioned valve part 71a or valve part 71b and the valve part 71c are opened, the cleaning liquid supplied from the cleaning tank 75 will flow through the opened valve parts into the flow passages connected to the given valve parts.

Furthermore, valve part 71d is connected to the discharge tank 76 (more specifically to an unillustrated flow passage that is connected to the discharge tank 76). Therefore, for example, during cleaning, if one of the aforementioned valve part 71a or valve part 71b and the valve part 71d are opened, the cleaning liquid or air that has flowed through the flow passages connected to the opened valve parts will flow through valve part 71d into the discharge tank 76.

In the return flow passage 49, a gear pump 72 is connected to the downstream side of flow passage 49c. The gear pump 72 is arranged, for example, inside the second turning arm 28 of the robot arm 23. The gear pump 72 draws in coating material flowing through the return flow passage 49 and feeds it into the flow passage 49d connected on the downstream side of the gear pump 72. Therefore, in the return flow passage 49, flow passage 49c goes to negative pressure, and coating material is drawn into the return flow passage 49 and then fed from the gear pump 72 into the flow passage 49d connected to the downstream side of the gear pump 72. Here, the gear pump 72 corresponds to the second pump as set forth in the claims.

In the return flow passage 49, a three-way valve 73 is connected to the downstream side of flow passage 49d. The three-way valve 73 switches between a state in which flow passage 49d is interconnected with flow passage 49e, connected to the coating material tank 46, and a state in which flow passage 49d is interconnection with the discharge tank 76. During painting of the vehicle body FR by means of the painting head 47 or during circulation of coating material, the three-way valve 73 maintains the flow passage 49d and flow passage 49e in an interconnected state. Furthermore, during cleaning, the three-way valve 73 switches from a state in which flow passage 49d is interconnected to flow passage 49e to a state in which flow passage 49d is interconnected to the discharge tank 76. As a result, the cleaning liquid and air flowing through flow passage 49e are discharged via the three-way valve 73 into the discharge tank 76.

The aforementioned coating material circulation passage 41 is divided into multiple segments, and each of the divided segments can be cleaned individually. The multiple segments are, for example, a segment going from the three-way valve 65 via gear pump 61 to switching valve 66; a segment going from switching valve 66 via the removal filter 62 to switching valve 67; a segment going from switching valve 67 via the deaeration module 63 to switching valve 68; a segment going from switching valve 68 via the painting head 47 to switching valve 71; and a segment going from switching valve 71 via gear pump 72 to three-way valve 73.

In the following the segment going from the three-way valve 65 via gear pump 61 to switching valve 66 will be referred to as first gear pump section GS1; the segment going from switching valve 66 via the removal filter 62 to switching valve 67 will be referred to as filter section FS; and the segment going from switching valve 67 via the deaeration module 63 to switching valve 68 will be referred to as degassing section DS. Furthermore, the segment going from switching valve 68 via painting head 47 to switching valve 71 will be referred to as head section HS, and the segment going from switching valve 71 via gear pump 72 to three-way valve 73 will be referred to as second gear pump section GS2. The aforementioned head section HS shall be considered to include the bypass flow passage 50.

Among the aforementioned multiple segments, cleaning of the first gear pump section GS1 is performed by opening the valve parts 66a, 66c of switching valve 66 and supplying cleaning liquid and air via valve part 66c of switching valve 66 to the first gear pump section GS1. At this time, the three-way valve 65 may be held in a state in which flow passage 48b is interconnected with the discharge tank 76, or may be switched to a state in which flow passage 48b is interconnected with the discharge tank 76 once a predetermined period of time has elapsed after supplying cleaning liquid and air via valve section 66c of switching valve 66 to the first gear pump section GS1. As a result, the cleaning liquid and air are supplied though valve part 66c of switching valve 66 to the first gear pump section GS1, and are discharged via the three-way valve 65 to the discharge tank 76 after flowing in a direction opposite to the supply direction of coating material during painting of the vehicle body FR by the painting robot 11. It should be noted that cleaning of the first gear pump section GS1 is carried out by performing the operation of passing through cleaning liquid and air in that order one or multiple times. Here, the duration and number of repetitions of passing through cleaning liquid and air may be set at one's discretion.

Cleaning of the filter section FS is carried out by opening valve parts 67a, 67c of switching valve 67 and supplying cleaning agent and air via switching valve 67 to the filter section FS. At this time, valve parts 66b, 66d of the switching valve 66 may be opened simultaneously with valve parts 67a, 67c of switching valve 67, or they may be opened once a predetermined period of time has elapsed after supplying cleaning liquid and air through valve part 67c of switching valve 67 to the filter section FS. As a result, the cleaning liquid and air are supplied though valve part 67c of switching valve 67 to the filter section FS, and are discharged into the discharge tank 76 via the valve part 66d of switching valve 66 after flowing in a direction opposite to the supply direction of coating material during painting of the vehicle body FR by the painting robot 11. It should be noted that cleaning of the filter section FS is carried out by performing the operation of, for example, passing through cleaning liquid and air in that order one or multiple times. Here, the duration and number of repetitions of passing through cleaning liquid and air may be set at one's discretion.

Furthermore, cleaning of the filter section FS may be carried out by opening valve parts 66b, 66c of switching valve 66 and supplying cleaning agent and air via switching valve 66 to the filter section FS. In this case, valve parts 67a, 67d of the switching valve 67 may be opened simultaneously with valve parts 66b, 66c of switching valve 66, or they may be opened once a predetermined period of time has elapsed after supplying cleaning liquid and air through valve part 66c of switching valve 66 to the filter section FS. As a result, the cleaning liquid and air are supplied though valve part 66c of switching valve 66 to the filter section FS, and are discharged into the discharge tank 76 via the valve part 67d of switching valve 67 after flowing in the same direction as the supply direction of coating material during painting of the vehicle body FR by the painting robot 11. In this case, cleaning of the filter section FS is carried out by performing the operation of, for example, passing through cleaning liquid and air in that order one or multiple times. It should be noted that the duration and number of repetitions of passing through cleaning liquid and air may be set at one's discretion.

Cleaning of the degassing section DS is carried out by opening valve parts 68a, 68c of switching valve 68 and supplying cleaning agent and air via switching valve 68 to the degassing section DS. At this time, valve parts 67b, 67d of the switching valve 67 may be opened simultaneously with valve parts 68a, 68c of switching valve 68, or they may be opened once a predetermined period of time has elapsed after supplying cleaning liquid and air through valve part 68c of switching valve 68 to the degassing section DS. As a result, the cleaning liquid and air are supplied though valve part 68c of switching valve 68 to the degassing section DS, and are discharged into the discharge tank 76 via the valve part 67d of switching valve 67 after flowing in the opposite direction to the supply direction of coating material during painting of the vehicle body FR by the painting robot 11. It should be noted that cleaning of the degassing section DS is carried out by performing the operation of, for example, passing through cleaning liquid and air in that order one or multiple times. Here, the duration and number of repetitions of passing through cleaning liquid and air may be set at one's discretion.

Furthermore, cleaning of the degassing section DS may be carried out by opening valve parts 67b, 67c of switching valve 67 and supplying cleaning agent and air via switching valve 67 to the degassing section DS. In this case as well, valve parts 68a, 68d of the switching valve 68 may be opened simultaneously with valve parts 67b, 67c of switching valve 67, or they may be opened once a predetermined period of time has elapsed after supplying cleaning liquid and air through valve part 67c of switching valve 67 to the filter section FS. At this time, the cleaning liquid and air are supplied though valve part 67c of switching valve 67 to the degassing section DS, and are discharged into the discharge tank 76 via the valve part 68d of switching valve 68 after flowing in the same direction as the supply direction of coating material during painting of the vehicle body FR by the painting robot 11. In this case as well, cleaning of the degassing section DS is carried out by performing the operation of, for example, passing through cleaning liquid and air in that order one or multiple times. It should be noted that the duration and number of repetitions of passing through cleaning liquid and air may be set at one's discretion.

The head section HS, as described above, includes the bypass flow passage 50, and during cleaning of the head section HS, the cleaning is performed in the order bypass flow passage 50—painting head 47—bypass flow passage 50. First, valve parts 71a, 71c of switching valve 71 are opened. Furthermore, the three-way valve 69 is maintained in a state in which flow passage 48h is interconnected with bypass flow passage 50. Furthermore, the three-way valve 70 is maintained in a state in which bypass flow passage 50 is interconnected with flow passage 49b. As a result, the cleaning liquid and air are supplied though valve part 71c of switching valve 71 to the head section HS, and flow through the bypass flow passage 50 in the opposite direction to the supply direction of coating material during painting of the vehicle body FR by the painting robot 11. It should be noted that valve parts 68b, 68d of switching valve 68 open once a predetermined period of time has elapsed after supplying cleaning liquid and air to the head section HS through valve part 71c of switching valve 71. As a result, the cleaning liquid and air flowing into the bypass flow passage 50 of the head section HS are discharged via valve part 68d of switching valve 68 into the discharge tank 76. Then, once a predetermined period of time has elapsed after the cleaning liquid and air have been discharged through valve part 68d of switching valve 68 into the discharge tank 76, valve parts 68b, 68d of switching valve 68 are closed for a time. It should be noted that cleaning of the bypass flow passage 50 is carried out by performing the operation of, for example, passing through cleaning liquid and air in that order one or multiple times. Here, the duration and number of repetitions of passing through cleaning liquid and air may be set at one's discretion.

Next, three-way valve 69 is switched from a state in which the bypass flow passage 50 is interconnected with the flow passage 48h into a state in which flow passage 48h is interconnected with flow passage 48i, and at the same time, three-way valve 70 is switched from a state in which the bypass flow passage 50 is interconnected with flow passage 49b into a state in which flow passage 49a is interconnected with flow passage 49b. Cleaning liquid and air are supplied through valve parts 71a, 71c of switching valve 71 to the head section HS, and flow through flow passage 49a, painting head 47 and flow passage 48i in that order. It should be noted that valve parts 68b, 68d of switching valve 68 open once a predetermined period of time has elapsed after supplying cleaning liquid and air to the head section HS through valve part 71c of switching valve 71. As a result, discharge into the discharge tank 76 takes place via valve part 68d of switching valve 68. Then, once a predetermined period of time has elapsed after the cleaning liquid and air have been discharged through valve part 68d of switching valve 68 into the discharge tank 76, valve part 68d of switching valve 68 is closed for a time. It should be noted that cleaning of the painting head 47 is carried out by performing the operation of, for example, passing through cleaning liquid and air in that order one or multiple times. Here, the duration and number of repetitions of passing through cleaning liquid and air may be set at one's discretion.

Finally, three-way valve 69 is switched from a state in which flow passage 48h is interconnected with flow passage 48i into a state in which the bypass flow passage 50 is interconnected with flow passage 48h, and at the same time, three-way valve 70 is switched from a state in which flow passage 49a is interconnected with flow passage 49b into a state in which the bypass flow passage 50 is interconnected with flow passage 49b. The cleaning liquid and air are supplied though valve parts 71a, 71c of switching valve 71 to the head section HS, and flow through the bypass flow passage 50 in the opposite direction to the supply direction of coating material during painting of the vehicle body FR by the painting robot 11. It should be noted that valve parts 68b, 68d of switching valve 68 open once a predetermined period of time has elapsed after supplying cleaning liquid and air to the head section HS through valve part 71c of switching valve 71. As a result, the cleaning liquid and air flowing into the bypass flow passage 50 of the head section HS are discharged via valve part 68d of switching valve 68 into the discharge tank 76. Then, once a predetermined period of time has elapsed after the cleaning liquid and air have been discharged through valve part 68d of switching valve 68 into the discharge tank 76, valve parts 68b, 68d of switching valve 68 are closed for a time. It should be noted that cleaning of the bypass flow passage 50 is carried out by performing the operation of, for example, passing through cleaning liquid and air in that order one or multiple times. Here, the duration and number of repetitions of passing through cleaning liquid and air may be set at one's discretion.

It should be noted that, for cleaning of head section HS described above, rather than opening valve parts 71a, 71c of switching valve 71 and valve parts 68b, 68d of switching valve 68 and passing cleaning liquid and air through in the opposite direction to the supply direction of coating material during painting of the vehicle body FR by the painting robot 11, it is also possible to perform cleaning by maintaining valve parts 71a, 71d of switching valve 71 and valve parts 68b, 68c of switching valve 68 in an open state and passing through cleaning liquid and air in the same direction as the supply direction of coating material.

Cleaning of the second gear pump section GS2 is performed by opening the valve parts 71b, 71c of switching valve 71 and supplying cleaning liquid and air via valve part 71c of switching valve 71 to the second gear pump section GS2. At this time, the three-way valve 73 may be held in a state in which flow passage 49d is interconnected with the discharge tank 76, or may be switched to a state in which flow passage 49d is interconnected with discharge tank 76 once a predetermined period of time has elapsed after supplying cleaning liquid and air via valve section 71c of switching valve 71 to the second gear pump section GS2. As a result, the cleaning liquid and air are supplied though valve part 71c of switching valve 71 to the second gear pump section GS2, and are discharged via the three-way valve 73 to the discharge tank 76 after flowing in the same direction as the supply direction of coating material during painting of the vehicle body FR by the painting robot 11. It should be noted that cleaning of the second gear pump section GS2 is carried out by performing the operation of passing through cleaning liquid and air in that order one or multiple times. Here, the duration and number of repetitions of passing through cleaning liquid and air may be set at one's discretion.

The cleaning of the head section HS among the multiple segments described above will be explained more concretely below. In the following, the case will be described where the head section HS is cleaned by passing through cleaning liquid and air in the opposite direction to the supply direction of coating material.

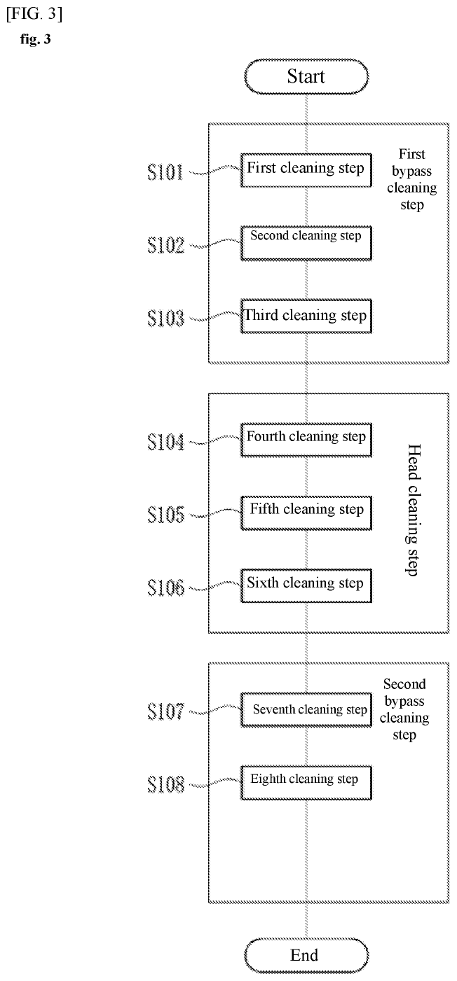

As shown in FIG. 3, the head section HS is cleaned in multiple steps. The steps for cleaning the head section HS include a first bypass cleaning step, a head cleaning step and a second bypass cleaning step. It should be noted that these steps are carried out, for example, by passing cleaning liquid or air through in the opposite direction to the supply direction of coating material during painting of the vehicle body FR by the painting robot 11. For example, the air pressure value for supplying air to the head section HS is set, as one example, at about 0.05 MPa to 0.2 MPa.

The first bypass cleaning step includes the following first cleaning step through third cleaning step. For the first cleaning step (step S101 in FIG. 3), first, cleaning liquid is supplied to flow passage 49b, bypass flow passage 50 and flow passage 48h, and after these flow passages have been filled with cleaning liquid, air (compressed air) is supplied into the flow passages. Supplying air into these flow passages causes all of the cleaning liquid that had been filled into these flow passages to be discharged. In the first cleaning step, the operation described above is taken to be one turn, and the above-described operation is performed for one or multiple turns. Here, the time during which cleaning liquid or air is to be supplied is set at one's discretion according to the type of coating material used, the capacity of the flow passages, etc.

For the second cleaning step (step S102 in FIG. 3), first, a predetermined quantity of cleaning liquid is supplied to flow passage 49b, bypass flow passage 50 and flow passage 48h, after which air is supplied into these flow passages. Supplying air into the flow passages causes all of the cleaning liquid that had been filled into these flow passages to be discharged. In the second cleaning step, the operation described above is taken to be one turn, and one or multiple such turns are performed. Here, the quantity of cleaning liquid to be supplied is set at one's discretion according to the type of coating material used, the capacity of the flow passages, etc. Furthermore, the time during which cleaning liquid or air is to be supplied is set at one's discretion according to the type of coating material used, the capacity of the flow passages, etc.

Furthermore, in the second cleaning step, when the above-described operation is performed for multiple turns, the quantity of cleaning liquid supplied may be the same for all the turns, or alternatively, an identical quantity of cleaning liquid may be supplied for each turn up to a predetermined number of turns from the start of the second cleaning step, and a different quantity of cleaning liquid may be supplied during subsequent turns. In this case, the second cleaning step may also be treated as multiple different cleaning steps according to the quantity of cleaning liquid supplied.

For the third cleaning step (step S103 in FIG. 3), first, cleaning liquid is supplied to flow passage 49b, bypass flow passage 50 and flow passage 48h, and after these flow passages have been filled with cleaning liquid, air is supplied into the flow passages. Supplying air into these flow passages causes all of the cleaning liquid that had been filled into these flow passages to be discharged. In the third cleaning step, the operation described above is taken to be one turn, and the above-described operation is performed for one or multiple turns. Here, the time during which cleaning liquid or air is to be supplied is set at one's discretion according to the type of coating material used, the capacity of the flow passages, etc.

The bypass flow passage 50 is cleaned by performing the first bypass cleaning step including the aforementioned first through third cleaning steps. Then, once the first bypass cleaning step has been completed, the head cleaning step is started. The head cleaning step includes the following fourth cleaning step through sixth cleaning step.

For the fourth cleaning step (step S104 in FIG. 3), cleaning liquid is supplied to flow passage 49b, flow passage 49a, the flow passages inside the painting head 47, flow passage 48i and flow passage 48h, and after these flow passages have been filled with cleaning liquid, air is supplied into the flow passages. Supplying air into these flow passages causes all of the cleaning liquid that had been filled into these flow passages to be discharged. In the fourth cleaning step, the operation described above is taken to be one turn, and the above-described operation is performed for one or multiple turns. Here, the time during which cleaning liquid or air is to be supplied is set at one's discretion according to the type of coating material used, the capacity of the flow passages, etc.

For the fifth cleaning step (step S105 in FIG. 3), after supplying a predetermined quantity of cleaning liquid into flow passage 49b, flow passage 49a, the flow passages inside the painting head 47, flow passage 48i and flow passage 48h, air is supplied. Supplying air into these flow passages causes all of the cleaning liquid that had been supplied into these flow passages to be discharged. In the fifth cleaning step, the operation described above is taken to be one turn, and one or multiple such turns are performed. It should be noted that, in the fifth cleaning step, the quantity of cleaning liquid to be supplied may be the same quantity as in the second cleaning step or a different quantity. Furthermore, the time during which cleaning liquid or air is to be supplied is set at one's discretion according to the type of coating material used, the capacity of the flow passages, etc.

Furthermore, in the fifth cleaning step, when the above-described operation is performed for multiple turns, the quantity of cleaning liquid supplied may be the same for all the turns, or alternatively, an identical quantity of cleaning liquid may be supplied for each turn up to a predetermined number of turns from the start of the fifth cleaning step, and a different quantity of cleaning liquid may be supplied during subsequent turns. In this case, the fifth cleaning step may also be treated as multiple different cleaning steps according to the quantity of cleaning liquid supplied.

For the sixth cleaning step (step S106 in FIG. 3), cleaning liquid is supplied to flow passage 49b, flow passage 49a, the flow passages inside the painting head 47, flow passage 48i and flow passage 48h, and after these flow passages have been filled with cleaning liquid, air is supplied into the flow passages. Supplying air into these flow passages causes all of the cleaning liquid that had been filled into these flow passages to be discharged. In the sixth cleaning step, the operation described above is taken to be one turn, and the above-described operation is performed for one or multiple turns. Here, the time during which cleaning liquid or air is to be supplied is set at one's discretion according to the type of coating material used, the capacity of the flow passages, etc.

The flow passage 49a, the flow passages inside the painting head 47, and flow passage 48i are cleaned by performing the head cleaning step including the fourth through sixth cleaning steps described above. Then, once the head cleaning step has been completed, the second bypass cleaning step is started. The second bypass cleaning step includes the following seventh cleaning step and eighth cleaning step.

For the seventh cleaning step (step S107 in FIG. 3), first, a predetermined quantity of cleaning liquid is supplied into flow passage 49b, bypass flow passage 50 and flow passage 48h, after which air is supplied into these flow passages. Supplying air into these flow passages causes all of the cleaning liquid that had been supplied into these flow passages to be discharged. In the second cleaning step, the operation described above is taken to be one turn, and one or multiple such turns are performed. Here, in the seventh cleaning step, the quantity of cleaning liquid to be supplied may be the same quantity as in the second cleaning step or a different quantity. Furthermore, the time during which cleaning liquid and air are to be supplied may be the same as the time in the second cleaning step or a different time.

Furthermore, in the seventh cleaning step, when the above-described operation is performed for multiple turns, the quantity of cleaning liquid supplied may be the same for all the turns, or alternatively, an identical quantity of cleaning liquid may be supplied for each turn up to a predetermined number of turns from the start of the seventh cleaning step, and a different quantity of cleaning liquid may be supplied during subsequent turns. In this case, the seventh cleaning step may also be treated as multiple different cleaning steps according to the quantity of cleaning liquid supplied.

For the eighth cleaning step (step S108 in FIG. 3), first, cleaning liquid is supplied to flow passage 49b, bypass flow passage 50 and flow passage 48h, and after these flow passages have been filled with cleaning liquid, air is supplied into the aforesaid flow passages. Supplying air into these flow passages causes the cleaning liquid that had been filled into these flow passages to be discharged. In the eighth cleaning step, the operation described above is taken to be one turn, and the above-described operation is performed for one or multiple turns. Here, the time during which cleaning liquid and air are to be supplied may be the same as the time in the third cleaning step or a different time.

The bypass flow passage 50 is cleaned again by performing the second bypass cleaning step including the aforementioned seventh and eighth cleaning steps. Cleaning of the head section HS is carried out by performing the first bypass cleaning step, head cleaning step and second bypass cleaning step described above.

It should be noted that while the details regarding the other sections will be omitted, the cleaning is performed in accordance with a cleaning method (cleaning steps) appropriate for the section to be cleaned. Accordingly, cleaning can be performed by a cleaning method appropriate for each section, and as a result, a cleaning effect can be obtained for each section. Furthermore, since cleaning liquid and air are not passed along the coating material circulation passage 41 from the upstream side of the coating material circulation passage 41, it becomes possible to shorten the cleaning time required until the flow passages on the downstream side of the coating material circulation passage 41 and the component parts possessed by the coating material circulation passage 41 have been cleaned.

While it was indicated that the above-described multiple segments can be cleaned independently, it will be noted that the term cleaning independently includes not only cleaning the multiple segments one by one in sequence, but also simultaneously cleaning two adjacent segments from among the multiple segments and simultaneously cleaning every other segment from among the multiple segments.

Therefore, it is also possible to simultaneously clean adjacent segments such as the filter section FS and degassing section DS. For example, in the case of simultaneously cleaning the filter section FS and degassing section DS, for example, valve parts 67a, 67b, 67c of switching valve 67 located between the removal filter 62 and deaeration module 63 are opened, and valve part 66d of switching valve 66 and valve part 68d of switching valve 68 are also opened. As a result, cleaning liquid or air is supplied via valve part 67c of switching valve 67 to the filter section FS and the degassing section DS and is then discharged into the discharge tank 76 via valve part 66d of switching valve 66 and valve part 68d of switching valve 68.

Furthermore, for example, in the case of simultaneously cleaning the filter section FS and degassing section DS, rather than passing cleaning liquid and air through valve part 67c of switching valve 67, it is also possible to pass cleaning liquid and air through valve part 66c of switching valve 66 or valve part 68c of switching valve 68. In this case, the switching valve 67 arranged between the removal filter 62 and the deaeration module 63 is maintained in a state with the valve parts 67a, 67b open, so that cleaning liquid and air flow through the filter section FS and degassing section DS in that order (or the opposite order) and are then discharged into the discharge tank 76.

It should be noted that while the filter section FS and degassing section DS were divided here into multiple segments, it is also possible to treat the filter section FS and degassing section DS as a single segment. In the following, an example of the case where the filter section FS and degassing section DS are cleaned as a single segment will be described.

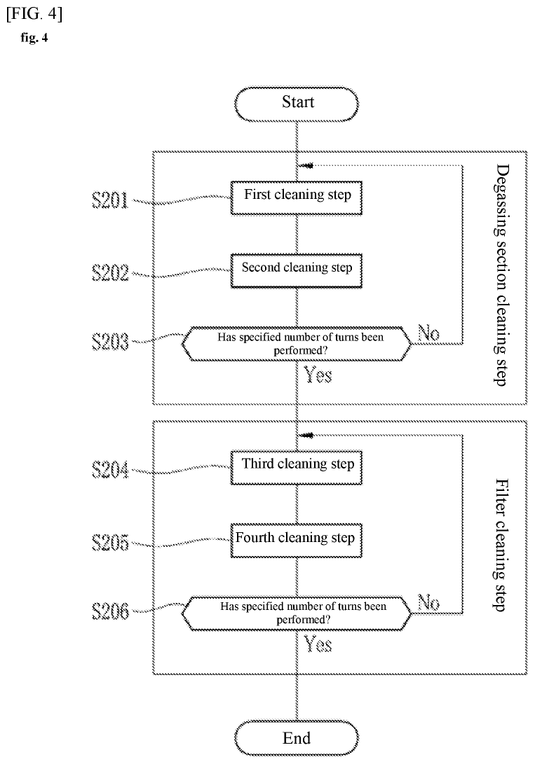

As shown in FIG. 4, the cleaning steps include a degassing section cleaning step and a filter cleaning step. In the case where the filter section FS and degassing section DS are cleaned as a single segment, valve part 67c of switching valve 67 is opened and cleaning liquid and air are supplied to each section. Namely, for the degassing section DS, cleaning liquid and air are supplied in the same direction as the supply direction of coating material to perform cleaning, and for the filter section FS, cleaning liquid and air are supplied in the opposite direction to the supply direction of coating material to perform cleaning. It should be noted that, in the case where the filter section FS and degassing section DS are cleaned as a single segment, the switching valves that are opened in order to supply cleaning liquid and air to each section may be changed for each section. It should be noted that, in the description presented below, the pressure of air supplied for cleaning filter section FS and degassing section DS is set, as one example, at about 0.2 MPa to 0.6 MPa. It should be noted that the pressure of the air supplied during cleaning of the other segments besides the head section HS may either be the same pressure or a different pressure from the pressure of the air supplied for cleaning the filter section FS and degassing section DS.

The degassing section cleaning step includes a first cleaning step and a second cleaning step. For the first cleaning step, (step S201 in FIG. 4), first, cleaning liquid is supplied into flow passage 48f, the flow passages inside the deaeration module 63, and flow passage 48g, and after cleaning liquid has been filled into these flow passages, air (compressed air) is supplied thereto. Supplying air into these flow passages causes all of the cleaning liquid that had been filled into these flow passages to be discharged. In the first cleaning step, the operation described above is taken to be one turn, and the above-described operation is performed for one or multiple turns. Here, the time during which cleaning liquid or air is to be supplied is set at one's discretion according to the type of coating material used, the capacity of the flow passages, etc.

For the second cleaning step, (step S202 in FIG. 4), first, a predetermined quantity of cleaning liquid is supplied into flow passage 48f, the flow passages inside the deaeration module 63, and flow passage 48g, after which air is supplied thereto. Supplying air into these flow passages causes a portion of the cleaning liquid that had been supplied into these flow passages to be discharged. In the second cleaning step, the operation described above is taken to be one turn, and one or multiple such turns are performed. Here, the quantity of cleaning liquid to be supplied to the aforementioned flow passages is set at one's discretion according to the type of coating material used, the capacity of the flow passages, etc. Furthermore, the quantity of cleaning liquid discharged is likewise set at one's discretion according to the type of coating material used, the capacity of the flow passages, etc. Moreover, the time during which cleaning liquid or air is to be supplied is set at one's discretion according to the type of coating material used, the capacity of the flow passages, etc. After the above-described operation has been performed for one or multiple turns, cleaning liquid is supplied into flow passage 48f, the flow passages inside the deaeration module 63, and flow passage 48g, filling these flow passages with cleaning liquid. It should be noted that the step of filling with cleaning liquid may also be treated as a different step from the second cleaning step.

Furthermore, in the second cleaning step, when the above-described operation is performed for multiple turns, the quantity of cleaning liquid supplied may be the same for all the turns, or alternatively, an identical quantity of cleaning liquid may be supplied for each turn up to a predetermined number of turns from the start of the second cleaning step, and a different quantity of cleaning liquid may be supplied during subsequent turns. In this case, the second cleaning step may also be defined as multiple different cleaning steps according to the quantity of cleaning liquid supplied.

Taking the above-described first cleaning step and second cleaning step as one turn, the above-described first cleaning step and second cleaning step are performed until a predetermined number of turns is reached (in FIG. 4, until the decision in step S203 is Yes). Then, once the predetermined number of turns has been reached (in FIG. 4, when the decision in step S203 is Yes), the degassing section cleaning step terminates and the process proceeds to the filter cleaning step. It should be noted that the predetermined number of turns is set at one's discretion according to the structure of the deaeration module 63 and the type of coating material used.

The filter cleaning step includes a third cleaning step and a fourth cleaning step. For the third cleaning step (step S204 in FIG. 4), first, cleaning liquid is supplied to flow passage 48e, the flow passages inside the removal filter 62, and flow passage 48d, and after these flow passages have been filled with cleaning liquid, air is supplied into the flow passages. Supplying air into these flow passages causes all of the cleaning liquid that had been filled into these flow passages to be discharged. In the third cleaning step, the operation described above is taken to be one turn, and the above-described operation is performed for one or multiple turns. Here, the time during which cleaning liquid or air is to be supplied is set at one's discretion according to the type of coating material used, the capacity of the flow passages, etc.

For the fourth cleaning step, (step S205 in FIG. 4), first, a predetermined quantity of cleaning liquid is supplied into flow passage 48e, the flow passages inside the removal filter 62, and flow passage 48d, after which air is supplied thereto. Supplying air into these flow passages causes a portion of the cleaning liquid that had been supplied into these flow passages to be discharged. In the fourth cleaning step, the operation described above is taken to be one turn, and one or multiple such turns are performed. Here, the quantity of cleaning liquid to be supplied to these flow passages is set at one's discretion according to the type of coating material used, the capacity of the flow passages, etc. Furthermore, the quantity of cleaning liquid discharged is likewise set at one's discretion according to the type of coating material used, the capacity of the flow passages, etc. Moreover, the time during which cleaning liquid or air is to be supplied is set at one's discretion according to the type of coating material used, the capacity of the flow passages, etc. After the above-described operation has been performed for one or multiple turns, cleaning liquid is supplied into flow passage 48e, the flow passages inside the removal filter 62, and flow passage 48d, filling these flow passages with cleaning liquid. It should be noted that the step of filling with cleaning liquid may also be treated as a different step from the fourth cleaning step.

Furthermore, in the fourth cleaning step, when the above-described operation is performed for multiple turns, the quantity of cleaning liquid supplied may be the same for all the turns, or alternatively, an identical quantity of cleaning liquid may be supplied for each turn up to a predetermined number of turns from the start of the seventh cleaning step, and a different quantity of cleaning liquid may be supplied during subsequent turns. In this case, the fourth cleaning step may also be defined as multiple different cleaning steps according to the quantity of cleaning liquid supplied.

Taking the above-described third cleaning step and fourth cleaning step as one turn, the above-described third cleaning step and fourth cleaning step are performed until a predetermined number of turns is reached (in FIG. 4, until the decision in step S206 is Yes). Then, once the predetermined number of turns has been reached (in FIG. 4, when the decision in step S206 is Yes), the filter cleaning step terminates. It should be noted that the predetermined number of turns is set at one's discretion according to the structure of the removal filter 62 and the type of coating material used.

By performing the degassing section cleaning step and filter section cleaning step in this manner, a segment including the filter section FS and the degassing section DS can be cleaned as a single segment.

<Effect>

The present embodiment is a painting robot 11 equipped with a painting head 47 having multiple nozzles 51 that discharge coating material, characterized in that it comprises a supply passage 48 that supplies coating material to the painting head 47, and a return flow passage 49 that returns, to the upstream side of the supply passage 48, the portion of the coating material supplied to the painting head 47 that was not discharged from the multiple nozzles 51 possessed by the painting head 47, wherein the supply passage 48, the painting head 47 and the return flow passage 49 constitute a coating material circulation passage 41, wherein the coating material circulation passage 41 is divided into multiple segments GS1, FS, DS, HS, GS2 each of which includes at least one of the multiple circuit component parts arranged in the coating material circulation passage 41 or the painting head 47, wherein the coating material circulation passage 41 allows the multiple divided segments GS1, FS, DS, HS, GS2 to be cleaned individually.

For example, if circuit component parts besides the painting head 47, such as pumps 61, 72, deaeration module (remover) 63, removal filter 62, etc. are arranged in the coating material circulation passage 41 and coating material is circulated, the state of adhesion of coating material in painting head 47 and the aforementioned circuit component parts will differ for each part, and the manner in which the coating material comes off will also differ. Therefore, in the case of a cleaning method wherein cleaning liquid is passed through from the upstream side of the supply passage 58 making up the coating material circulation passage 41 to clean the coating material circulation passage 41, ingredients (for example, pigment) contained in the coating material will tend to remain in areas where coating material is difficult to wash away with the cleaning liquid, such as at concavoconvexities or level differences due to the structure of the inside of the coating material circulation passage 41. Furthermore, in the case of a method of cleaning the coating material circulation passage 41 by rinsing with cleaning liquid from the upstream side of the supply passage 48, ingredients of the coating material removed by cleaning will flow to the downstream portion of the coating material circulation passage 41 along with the cleaning liquid, making it more difficult to obtain a cleaning effect from the cleaning liquid on the downstream side of the coating material circulation passage 41. As a result, there is the problem that, in a method of cleaning the coating material circulation passage 41 by passing cleaning liquid through starting from the upstream side of the supply passage 48, the cleaning time is prolonged.

In the present invention, the coating material circulation passage 41 is divided into multiple segments, each of which contains at least one of multiple circuit component parts or the painting head 47, and individual cleaning of the divided segments is enabled. This makes it possible to perform cleaning in the segment that is to be cleaned using a cleaning method appropriate for the circuit component parts arranged in that segment. Thus, compared to the cleaning method in which the coating material circulation passage 41 is cleaned by passing through cleaning liquid starting from the upstream side of the supply passage 48, the cleaning effect of the cleaning liquid (high cleaning performance) can be more readily obtained. Furthermore, compared to a cleaning method in which the entire coating material circulation passage 41 is cleaned by passing through cleaning liquid starting from the upstream side of the supply passage 48, the cleaning time can be shortened.

Furthermore, the multiple segments include a first gear pump section GS1 in which a gear pump 61 that feeds coating material to the painting head 47 is arranged.

This makes it possible to clean the first gear pump section GS1 in which the gear pump 61 is arranged by a cleaning method appropriate for the structure of the gear pump 61. Thus, the cleaning performance in respect of the first gear pump section GS1 can be improved.

Furthermore, the multiple segments include a filter section FS in which there is arranged a removal filter 62 which removes aggregates contained in the coating material fed by the gear pump 61 toward the painting head 47.

This makes it possible to clean the filter section FS in which the removal filter 62 is arranged by a cleaning method appropriate to the structure of the removal filter 62. Thus, the cleaning performance in respect of the filter section FS can be improved.

Furthermore, the multiple segments include a degassing section DS in which there is arranged a deaeration module 63 which removes air bubbles contained in the coating material fed from the gear pump 61.

This makes it possible to clean the degassing section DS in which the deaeration module 63 is arranged by a cleaning method appropriate for the structure of the deaeration module 63. Thus, the cleaning performance in respect of the degassing section DS can be improved.

Furthermore, the multiple segments include a head section HS in which the painting head 47 is arranged.

This makes it possible to clean the head section HS in which the painting head 47 is arranged by a cleaning method appropriate for the structure of the painting head 47. Thus, the cleaning performance in respect of the head section HS can be improved.

Furthermore, the head section HS in which the painting head 47 is arranged includes a bypass flow passage 50 which enables flow to the return flow passage 49 without going through the painting head 47.

This makes it possible to clean the bypass flow passage 50 simultaneously along with cleaning of the painting head 47 in the case of a configuration wherein coating material is circulated within the coating material circulation passage 41 even when painting is not being performed by the painting head 47.

Furthermore, the multiple segments include a second gear pump section GS2, in which there is arranged a gear pump 72 which draws into the return flow passage 49, and feeds to the upstream side of the supply passage 48, the coating material supplied to the painting head 47 which was not discharged through the multiple nozzles 51 possessed by the painting head 47.

This makes it possible to clean the second gear pump section GS2 in which the gear pump 72 is arranged by a cleaning method appropriate for the structure of the gear pump 72. Thus, the cleaning performance in respect of the second gear pump section GS2 can be improved.

Furthermore, the coating material circulation passage 41 is divided into the multiple segments GS1, FS, DS, HS, GS2 by arranging switching valves 66, 67, 68, 71 at multiple locations, wherein the switching valves 66, 67, 68, 71 include a first valve part 66a, 66b, 67a, 67b, 68a, 68b, 71a, 71b which is opened when, between two adjacent segments, the coating material is to be passed from the segment located upstream to the segment located downstream in the coating material supply direction; a second valve part 66c, 67c, 68c, 71c which is opened when cleaning liquid or air is to be fed into one of the two adjacent segments; and a third valve part 66d, 67d, 68d, 71d which is opened when the cleaning liquid or the air that has flowed through one of the two adjacent segments is to be discharged to the outside.

This makes it possible to clear the segment that is to be cleaned simply through switching of the valve parts possessed by the switching valves. Furthermore, not only cleaning liquid but also air can be passed to the segment that is to be cleaned, making it possible to modify the method of cleaning for each segment, for example, by passing cleaning liquid and air in alternation to the segment that is to be cleaned. Thus, the cleaning performance in respect of all the segments and the segment in question is improved.

Furthermore, the cleaning of each segment among the multiple segments GS1, FS, DS, HS, GS2 is carried out by repeating, one or multiple times, the operation of supplying the cleaning liquid to the segment that is to be cleaned, then supplying the air to that segment, and discharging at least a portion of the supplied cleaning liquid, wherein the supplied quantity of the cleaning liquid and the air in the cleaning operation and the number of repetitions of the cleaning operation differ for each segment among the multiple segments GS1, FS, DS, HS, GS2.

This makes it possible to clean the segments using a cleaning method optimal for each of the multiple segments, thus making it easier to obtain a cleaning effect (high cleaning performance) from the cleaning liquid on the coating material circulation passage, and making it possible to shorten the cleaning time for cleaning the entire coating material circulation passage 41.

Furthermore, a painting robot 11, which has a robot arm 23 that holds the painting head 47 and paints a vehicle body FR by actuating the robot arm 23 and discharging coating material from multiple nozzles 51 possessed by the painting head 47, is used as a painting device.

Accordingly, when changing the coating material used in the process of painting a vehicle body FR using the painting robot 11, the coating material circulation passage 41 needs to be cleaned, and compared to a cleaning method in which cleaning liquid is passed through the coating material circulation passage 41 from the upstream side, a cleaning effect (high cleaning performance) of the cleaning liquid is easier to obtain and the cleaning time for cleaning the entire coating material circulation passage 41 can be shortened. Therefore, the painting efficiency of painting a vehicle body FR using the painting robot 11 can be increased.

### DESCRIPTION OF REFERENCE SYMBOLS

11 . . . Painting robot (painting device)
46 . . . Coating material tank
47 . . . Painting head
48 . . . Supply passage
49 . . . Return flow passage
50 . . . Bypass flow passage
51 . . . Nozzle
61 . . . Gear pump (first pump)
62 . . . Removal filter (filter)
63 . . . Deaeration module (remover)
66, 67, 68, 71 . . . Switching valve
66a, 66b, 67a, 67b, 68a, 68b, 71a, 71b . . . Valve part (first valve part)
66c, 67c, 68c, 71c . . . Valve part (second valve part)
66d, 67d, 68d, 71d . . . Valve part (third valve part)
72 . . . Gear pump (second pump)
DS . . . Degassing section; FS . . . Filter section
GS1 . . . First gear pump section
GS2 . . . Second gear pump section
HS . . . Head section

1. A painting device comprising:
a painting head which includes multiple nozzles configured to discharge a coating material;
a supply passage that supplies the coating material to the painting head; and
a return flow passage that returns, to the upstream side of the supply passage, the portion of the coating material supplied to the painting head that was not discharged from the multiple nozzles possessed by the painting head,
wherein,
the supply passage, the painting head, and the return flow passage constitute a coating material circulation passage;
the coating material circulation passage is divided into multiple segments, each of which contains at least one of the multiple circuit component parts arranged in the coating material circulation passage or the painting head; and
the coating material circulation passage allows the multiple segments to be cleaned individually.

2. The painting device as set forth in claim 1, wherein the multiple segments include a segment in which a first pump that feeds the coating material to the painting head is arranged.

3. The painting device as set forth in claim 2, wherein the multiple segments include a segment in which a filter for removing aggregates contained in the coating material fed from the first pump is arranged.

4. The painting device as set forth in claim 2, wherein the multiple segments include a segment in which a remover for removing air bubbles contained in the coating material fed from the first pump is arranged.

5. The painting device as set forth in claim 2, wherein the multiple segments include a segment in which the painting head is arranged.

6. The painting device as set forth in claim 5, wherein the segment in which the painting head is arranged includes a bypass flow passage that causes the coating material supplied to the given segment to flow to the return flow passage without going through the painting head.

7. The painting device as set forth in claim 1, wherein the multiple segments include a segment in which there is arranged a second pump which draws into the return flow passage, and feeds to the upstream side of the supply passage, the coating material supplied to the painting head that was not discharged from the multiple nozzles possessed by the painting head.

8. The painting device as set forth in claim 1, wherein the coating material circulation passage is divided into the multiple segments by arranging switching valves at multiple locations, wherein the switching valves include:
a first valve part which is opened when, between two adjacent segments, the coating material is to be passed from the segment located upstream to the segment located downstream in the coating material supply direction;
a second valve part which is opened when cleaning liquid or air is to be fed into one of the two adjacent segments; and
a third valve part which is opened when the cleaning liquid or the air that has flowed through one of the two adjacent segments is to be discharged to the outside.

9. The painting device as set forth in claim 8, wherein cleaning of each segment among said multiple segments is carried out by repeating, one or multiple times, the operation of supplying the cleaning liquid to the segment that is to be cleaned, then supplying the air to that segment, and discharging at least a portion of the supplied cleaning liquid, and
wherein the supplied quantity of the cleaning liquid and the air in the cleaning operation and the number of repetitions of the cleaning operation differ for each segment among the multiple segments.

10. The painting device as set forth in claim 1, wherein the painting device is a painting robot which has a robot arm that holds the painting head, and paints an object of painting through actuation of the robot arm and discharge of the coating material from the multiple nozzles possessed by the painting head.

11. The painting device according to claim 3, wherein the multiple segments include a segment in which a remover for removing air bubbles contained in the coating material fed from the first pump is arranged.

12. The painting device according to claim 11, wherein the multiple segments include a segment in which the painting head is arranged.

13. The painting device according to claim 12, wherein the segment in which the painting head is arranged includes a bypass flow passage that causes the coating material supplied to the given segment to flow to the return flow passage without going through the painting head.

14. The painting device according to claim 13, wherein the multiple segments include a segment in which there is arranged a second pump which draws into the return flow passage, and feeds to the upstream side of the supply passage, the coating material supplied to the painting head that was not discharged from the multiple nozzles possessed by the painting head.

15. The painting device according to claim 14, wherein the coating material circulation passage is divided into the multiple segments by arranging switching valves at multiple locations,
wherein the switching valves include:
a first valve part which is opened when, between two adjacent segments, the coating material is to be passed from the segment located upstream to the segment located downstream in the coating material supply direction;
a second valve part which is opened when cleaning liquid or air is to be fed into one of the two adjacent segments; and
a third valve part which is opened when the cleaning liquid or the air that has flowed through one of the two adjacent segments is to be discharged to the outside.

16. The painting device according to claim 15, wherein cleaning of each segment among said multiple segments is carried out by repeating, one or multiple times, the operation of supplying the cleaning liquid to the segment that is to be cleaned, then supplying the air to that segment, and discharging at least a portion of the supplied cleaning liquid, and wherein the supplied quantity of the cleaning liquid and the air in the cleaning operation and the number of repetitions of the cleaning operation differ for each segment among the multiple segments.

17. The painting device according to claim 16, wherein the painting device is a painting robot which has a robot arm that holds the painting head, and paints an object of painting through actuation of the robot arm and discharge of the coating material from the multiple nozzles possessed by the painting head.

18. The painting device according to claim 2, wherein the multiple segments include a segment in which there is arranged a second pump which draws into the return flow passage, and feeds to the upstream side of the supply passage, the coating material supplied to the painting head that was not discharged from the multiple nozzles possessed by the painting head.

19. The painting device according to claim 2, wherein the coating material circulation passage is divided into the multiple segments by arranging switching valves at multiple locations,
wherein the switching valves include:
a first valve part which is opened when, between two adjacent segments, the coating material is to be passed from the segment located upstream to the segment located downstream in the coating material supply direction;
a second valve part which is opened when cleaning liquid or air is to be fed into one of the two adjacent segments; and
a third valve part which is opened when the cleaning liquid or the air that has flowed through one of the two adjacent segments is to be discharged to the outside.

20. The painting device according to claim 2, wherein the painting device is a painting robot which has a robot arm that holds the painting head, and paints an object of painting through actuation of the robot arm and discharge of the coating material from the multiple nozzles possessed by the painting head.
